(19) United States
(12) Patent Application Publication
(10) Pub. No.: US 2018/0036765 A1
(43) Pub. Date: Feb. 8, 2018

(54) Screen Repair Apparatus and Method of Use

(71) Applicant: Justin Wayne Zzyzx, Newberry Springs, CA (US)

(72) Inventor: Justin Wayne Zzyzx, Newberry Springs, CA (US)

(73) Assignee: Liquid Glass Concepts, LP, Richardson, TX (US)

(21) Appl. No.: 15/226,455

(22) Filed: Aug. 2, 2016

(51) Int. Cl. B05D 1/28; B65D 35/44; B05D 3/04; B65D 35/36; C09D 1/02; G06F 3/041

(52) U.S. Cl. CPC B05D 1/28; C09D 1/02; G06F 3/0412; B05D 3/0413; B65D 35/36; B65D 35/44; G06F 2203/04103

(57) ABSTRACT

A screen repair system and method is disclosed. The system including containers holding solutions of sodium silicate and applicators to apply the solution to damaged areas of screens.

### FIELD OF THE DISCLOSURE

The invention relates generally to the field of repair apparatus for screens used on electronic devices.

### BACKGROUND

Many electronic devices have screens on one or more portions of the device. These screens are typically glass (or glasslike) pieces facilitating a visual display section of the device. Often these screens are touch screens that allow a user to operate the device through touching the screen.

At times, these screens may be broken creating one or more cracks in the screen itself. When the screen is broken, the cracks may have sharp and/or jagged edges that may cause injury to a user, the device to be unpleasant to operate and/or the device to be effectively inoperable. To repair the device, the screen is removed and replaced with a new screen.

### SUMMARY

The present disclosure provides a way to repair a cracked display screen without replacing the screen.

Embodiments of the present disclosure use a sodium metasilicate solution, sometimes referred to as a sodium silicate solution, to fill in the cracks of a broken screen. The sodium metasilicate solution has a sufficient viscosity to flow or be pressed into the cracks of a broken screen during application. Some embodiments of the present disclosure provide a kit including a container having a sodium metasilicate solution and an applicator.

Embodiments of the container include a seal covering a container output. In some embodiments, a cap is used as the seal for the container output. Some embodiments of the seal are replaceable, allowing for multiple uses. Other embodiments of the seal may not be replaceable.

Embodiments of the container output include openings designed to allow the sodium metasilicate solution to flow out of the container. In some embodiments, the container output may operate to direct the flow of the sodium metasilicate solution to specific locations. In some embodiments, the container output may operate to control the flow of the sodium metasilicate solution from the container.

Embodiments of the container may be designed for single-use applications or multiuse applications. Some embodiments of the container may be deformable to provide additional pressure within the container for moving the sodium metasilicate solution out of the container. In some embodiments, the container may be flexible such that the container resumes a default shape after being compressed.

Embodiments of the applicator include stick applicators with a broadened head to apply the sodium metasilicate solution into the cracks in the screen. In some embodiments, the stick applicator is made from a hard or semi-hard plastic. In some embodiments, the stick applicator may comprise multiple portions including a hard stick portion with a soft application portion. For example, the applicator may comprise a plastic stick with a foam head designed to apply the sodium metasilicate solution. Some embodiments of the applicator may be small foam or soft material blocks that may be used to spread the sodium metasilicate solution over the cracks of the screen.

In some embodiments, the applicator may be attached to the container. For example, a container may include a breakaway applicator connected to the side for use during application. Some embodiments may incorporate the applicator into a cap used on the container. In other embodiments, the applicator may be incorporated into the output of the container.

To repair a cracked screen, the sodium metasilicate solution may be applied out of the container onto the broken area of the display screen. An applicator may then be used to spread the sodium metasilicate solution over the cracked area of the broken screen. In some embodiments, the applicator may also be used to press the sodium metasilicate solution into the cracks. Once the sodium metasilicate solution is smoothed out over the broken surface of the screen, the sodium metasilicate solution is allowed to dry. Once completely dry, the screen is repaired and may be used again.

### A BRIEF DESCRIPTION OF THE DRAWINGS

Embodiments will now be described, by way of example only, with references to the accompanying drawings in which:

FIG. 1 shows an embodiment of a bottle and an electronic device with a damaged display;

FIG. 2 shows an embodiment of an applicator and an electronic device with a damaged display;

FIG. 3 shows an embodiment of a container;

FIG. 4 shows an exploded view of an embodiment of a container;

FIG. 5A shows an embodiment of a container;

FIG. 5B shows two views of an embodiment of a container tip;

FIG. 5C shows an embodiment of a cap with an applicator portion;

FIG. 6A shows an embodiment of an applicator; and

FIG. 6B shows another embodiment of an applicator.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

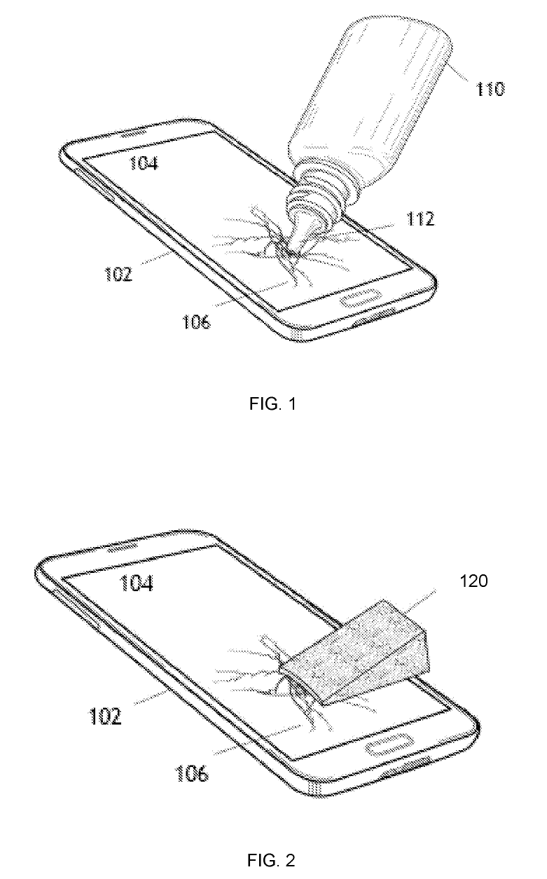

FIGS. 1 and 2 illustrate an application of a sodium metasilicate solution for repairing displays on electronic devices using a container and applicator. FIGS. 1 and 2 shows a smart phone 102 having a display 104. The smart phone 102 is shown as an illustrative electronic device. The screen repair process and elements described herein may be applied to other electronic devices having display screens. The display 104 may be a visual output only display or an input/output display, such as a touchscreen display element. The display 104 is shown with a damaged screen as illustrated by the cracks in damaged area 106. The cracks in the screen may be hairline fractures less than 1 mm wide or larger fissures such as 1 mm to 3 mm wide or larger.

In FIG. 1, a container 110 having a sodium silicate solution is shown over the smart phone 102. The sodium silicate solution comprises a mixture of sodium silicate and water. The sodium silicate may be mixed to a consistency ranging from a liquid to a gel. For example, the sodium silicate solution may be approximately 40% water and 60% sodium silicate to provide a semi-viscous liquid that will flow into small openings and spread over the surface. As another example, the sodium silicate solution may be approximately 10% water and 90% sodium silicate to provide a gel that can be spread over damaged surfaces and pressed into openings. Preferred embodiments of the sodium silicate solution may contain between 10% and 40% water. However, other embodiments may contain more than 40% water or less than 10% water. The sodium silicate solution may be tailored for specific uses. For example, a solution having 35% water and 65% sodium silicate may be used for damaged screens that predominantly have thin cracks. Alternatively, a solution having 13% water and 87% sodium silicate may be used for damaged screens with larger cracks and/or pits in the surface of the screen.

An output 112 of the container 110 is directed to the damaged area 106 of the screen. The sodium silicate solution is then applied to the damaged area 106 of the screen including the cracks. In some embodiments, the output 112 is designed to allow the sodium silicate solution to pour or drip from the container when the output is turned downward. In some embodiment, the output 112 is designed to hold the sodium silicate solution within the container 110 until an external force is applied to the container 110. For example, a user may hold the container 110 upside down over the damaged area and squeeze the container 110 when ready to apply the sodium silicate solution. The design of the output 112 may vary depending on the viscosity of the sodium silicate solution to achieve the desired output characteristics.

Once the sodium silicate solution is applied from the container 110 onto the damaged area 106, the sodium silicate solution is spread over the damaged area 106 using an applicator 120 as shown in FIG. 2. In this embodiment, the applicator 120 includes an application surface adjacent to the screen of the display 104. In some embodiments, the application surface may be a foam portion that is placed against the surface of the screen and moved over the damaged area 106 to ensure the sodium silicate solution covers the entire damaged area 106. Other applicator embodiments may use alternative materials for the application surface, such as plastic, nylon, cotton, metal or other materials. In some embodiments, the application surface may be designed as a brush, a flat edge, a solid flat application surface or other design. The selection of the material and design of the application surface may correlate to the consistency of the sodium silicate solution and/or the characteristics of the screen of the electronic device.

Some applicators may also include a handle portion that may be any design used to hold the applicator 120 during application of the sodium silicate solution. In some embodiments, the handle portion may be designed to attach to the container 110. For example, the handle portion may fit over the output 112 of the container 110 as a cap. For another example, the handle portion may be designed to snap onto the side of the container 110.

Once the sodium silicate solution is spread over the damaged area 106 with the applicator 120, the sodium silicate solution is allowed to dry. In some embodiments, a heat source and/or fan may be used to speed the drying process. Once dry the sodium silicate solution provides a solid seal smoothing out the rough edges of the cracks in the damaged area 106. The dry sodium silicate solution is safe to touch and allows the smart phone 102 to be used as a phone and for other purposes.

In some embodiments, the repair using the sodium silicate solution is designed as a temporary repair to allow the user to safely use the device for a limited timeframe until the screen or the device is replaced. In some embodiments, while allowing the display 104 to be fully visible through the damaged area 106, the dried sodium silicate solution may have a cloudy visual characteristic. In other embodiment, the sodium silicate solution may not be apparent on the screen once it has dried.

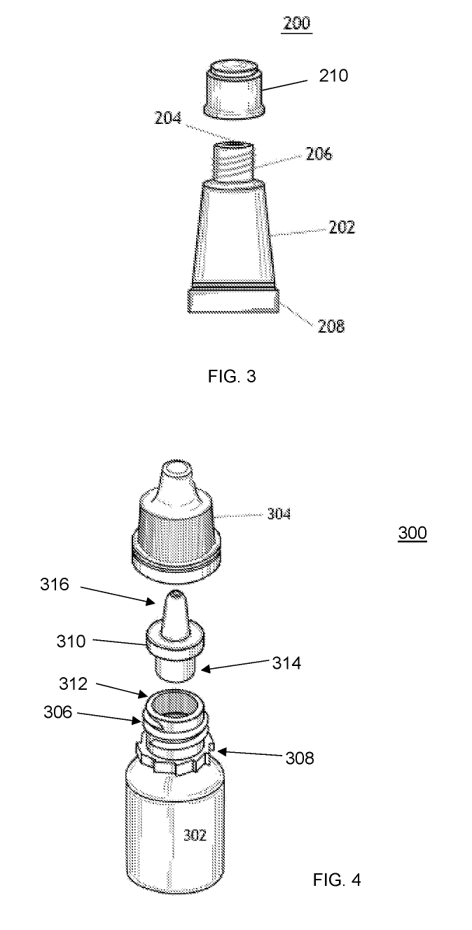

FIG. 3 shows a sleeve container 200 for holding a sodium silicate solution as described above. For example, the sodium silicate solution may comprise 37.5% sodium silicate and 63.5% water. For another example, the sodium silicate solution may comprise 55% sodium silicate and 45% water. The sleeve container 200 may also be referred to as a tube container. In this embodiment, the sleeve container 200 includes a container body 202 with a container output 204 located at one end of the sleeve container body 202. At the other end of the container body 202 is a seal 208. In this embodiment, the seal is shown as a crimped section at the base of the container body 202. The crimped section may be sealed in a variety of ways including compression seals, adhesives, heat seals and/or other seals. In some embodiments, the crimped section may be replaced with an alternative sealing component, such as a second removable cap, a plug or another sealing component.

A cap 210 is included in this embodiment to cover the output 204 when the sleeve container 200 is stored or otherwise not in use. In this embodiment, the output 204 includes a threaded section 206 compatible with an interior section of the cap 210, wherein the cap 210 may be removably secured to cover the output 204 by threading or screwing the cap 210 down on the threaded section 206 of the sleeve container body 202. In some embodiments, alternative connection or attachment components may be used to connect the cap 210 to the container body 202. For example, the cap may be connected to the container body 202 by a friction seal, a breakaway component and/or another connection.

In some embodiments, the sleeve container 202 may be intended to be a single use container having a select amount of a sodium silicate solution for a given project. In such embodiments, the cap 210 may be attached to the container body 202 by a single use connection. For example, the cap 210 may be attached by a breakaway plastic component, whereby when the cap 210 is removed it cannot be replaced on the container body 202.

In some embodiments, the sleeve container 202 may be compressible to allow a user to push the sodium silicate contents from the sleeve container 200 by compressing the container body 202. As the space within the container body 202 decreases, the internal pressure of the container body 202 will increase moving the sodium silicate solution through the output 204. In some embodiments, the output 204 may be designed to limit the release of the sodium silicate solution unless an increased pressure is applied to the container body 202. For example, the output 204 may comprise a fenestrated opening with slits to limit the release of the sodium silicate solution.

FIG. 4 illustrates a container 300 for holding a sodium silicate solution as described above. In this embodiment, the container 300 is shown as a bottle container. The container 300 includes a container body 302 with a container output 312 located at one end of the container body 302. In this embodiment, the container body only has the one opening at output 312.

A cap 304 is included in this embodiment to cover the output 312 when the container 300 is stored or otherwise not in use. In this embodiment, the output 312 includes a threaded section 306 compatible with an interior section of the cap 304, wherein the cap 304 may be removably secured to cover the output 312 by threading or screwing the cap 304 down on the threaded section 306 of the container body 302. In some embodiments, alternative connection or attachment components may be used to connect the cap 304 to the container body 302. For example, the cap 304 may be connected to the container body 302 by a friction seal, a breakaway component and/or another connection.

In this embodiment, the container body 302 includes a section of protrusions 308 below the threaded section 306. The protrusions 308 extend radially outward from the container body 302. In this embodiment, the interior of the cap 304 contains one or more detents corresponding to the protrusions 308. When the cap 304 is threaded onto the top of the container body 302 in a first direction (e.g. clockwise), the protrusions 308 and corresponding detents do not engage and allow rotation. When the cap 304 is rotated in the second direction, the protrusions 308 catch the detents preventing or increasing the difficulty to rotate the cap 304 in the second direction. In some embodiments, the section of the cap 304 having the detents may be designed to breakaway when a sufficient rotational pressure is applied to the cap 304. In other embodiments, the user may compress the section of the cap 304 having the detents at specific locations while the cap 304 is rotated to keep the detents from engaging during rotation in the second direction.

This embodiment also includes a reducer 310 that fits into the output 312 and provides a modified narrower output 316. The reducer base 314 is designed to correspond with the output 312 in this embodiment, such that the exterior circumference of the reducer base 314 creates a friction seal with the interior of the output 312. When a person uses the container 300 with reducer 310, the sodium silicate solution will pass through output 312, the reducer 310 and out through the modified narrower output 316. In some embodiments, the reducer 310 may be placed in the output 312 after the container body 302 is filled. In some embodiments, the reducer 310 may be removable to allow refilling the container 300 and/or pouring the sodium silicate solution. In other embodiments, the reducer 310 may be designed to prevent or hamper removal.

In some embodiments, the container 300 may be intended to be a single use container having a select amount of a sodium silicate solution for a given project. In such embodiments, the cap 304 may be attached to the container body 302 by a single use connection. For example, the cap 304 may be attached by a breakaway plastic component, whereby when the cap 304 is removed it cannot be replaced on the container body 302.

In some embodiments, the container 300 may be intended to be a multi-use container having an amount of a sodium silicate solution for multiple uses. In such embodiments, the cap 304 may be attached to the container body 302 by a connection that may be opened and closed. For example, the cap 304 may be attached by a threaded connection with a safety lock, whereby when the cap 304 is removed properly it can be replaced on the container body 302. While the container 300 may be designed as a multi-use container, it is possible that the type of project and extent of damage will affect the number of uses. For example, a container 300 designed for multiple uses in fixing minor damage to the screen of a mobile phone may only contain enough solution for fixing major damage to the screen of a tablet device.

In some embodiments, the container body 302 may be compressible to allow a user to push the sodium silicate contents from the container 300 by compressing the container body 302. As the space within the container body 302 decreases, the internal pressure of the container body 302 will increase moving the sodium silicate solution through the output 312 and the reducer output 316. In some embodiments, the reducer output 316 may be designed to limit the release of the sodium silicate solution unless an increased pressure is applied to the container body 302. For example, the reducer output 316 may comprise a fenestrated opening with slits to limit the release of the sodium silicate solution.

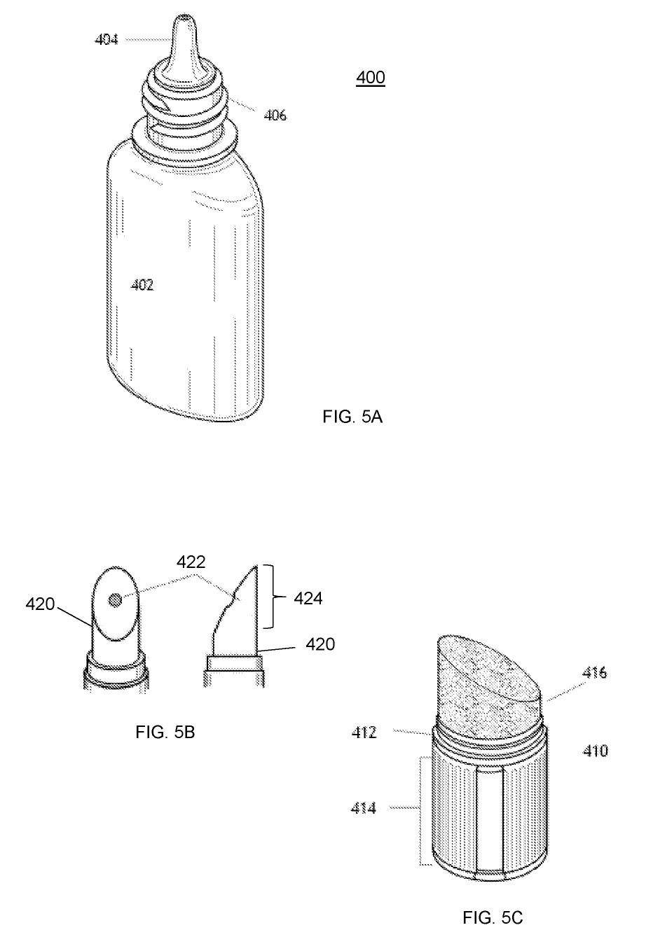

FIG. 5A shows another embodiment of a container 400 for holding a sodium silicate solution as described above. In this embodiment, the container 400 is shown as another bottle container. The container 400 includes a container body 402 with a container output 404 located at one end of the container body 402. In this embodiment, the container body 402 only has the one opening at output 404. As discussed with other embodiments, the container 400 may be designed as a single use container or a multi-use container.

A cap is not shown in FIG. 5A. In some embodiments, a cap such as those discussed elsewhere herein may be included to cover the output 404 when the container 400 is stored or otherwise not in use. In this embodiment, the container 400 includes a threaded section 406 that may be compatible with an interior section of a cap. In some embodiments, alternative connection or attachment components may be incorporated in the design of the container 400.

In some embodiments, the container body 402 may be compressible to allow a user to push the sodium silicate contents from the container 400 by compressing the container body 402. As the space within the container body 402 decreases, the internal pressure of the container body 402 will increase moving the sodium silicate solution through the output 404. In some embodiments, the output 404 may be designed to limit the release of the sodium silicate solution unless an increased pressure is applied to the container body 402. For example, the output 404 may comprise a sufficiently small opening that the sodium silicate solution will not pass through without additional applied pressure.

FIG. 5B illustrates a front view and a side view of an alternative container output 420. In this embodiment, the alternative output 420 includes the output opening 422 in an angled section 424 of the alternative output 420. The output opening 422 is fluidly connected to the internal opening of a container and allows the sodium silicate solution to be applied from the container through the output opening 422 onto an application surface. The angled section 424 may operate as an applicator to direct the sodium silicate solution to selected areas as the sodium silicate solution is applied from the output opening 422. In some embodiments, this operates as an initial application step with a separate applicator to conduct a subsequent application step for moving and smoothing the applied sodium silicate solution into the damaged area of a screen.

In some embodiments, the alternative output 420 may replace a container output, such as output 404 in FIG. 5A. In other embodiments, a user may cut a container output to create the angled section 424 of the alternative output 420. In such embodiments, a person may elect to create any desired angle for the angled section 424, whereby the user may customize the alternative output 420 for the specific application. In some designs, the container output may contain suggested angles for a user to cut. In some embodiments, the container may not have an output until a user cuts the tip of the container to create an output. In such embodiments, a cap and/or connections for a cap may not be necessary for single use designs.

FIG. 5C shows an embodiment of an applicator 410. The applicator 410 includes an application surface 416 and a base section 414. The application surface 416 may comprise a material that can smooth a sodium silicate solution into a damaged area of the screen. The material may be selected or designed to prevent or limit the likelihood of damage to the screen surface while facilitating the application of the sodium silicate solution. In some embodiments, the material may be a foam composite, a rubber, a plastic, a nylon and/or another material or combination of materials. In addition, alternative designs for the application surface 416 may be used in some embodiments. For example, the application surface 416 may be a solid or semi-solid flat surface. For another example, the application surface 416 may be a brush surface comprising a plurality of bristles.

The base section 414 may operate as a handle for a user to hold while applying the sodium silicate solution to the damaged area. In some embodiments, the base section 414 may include an internal opening with threads or other connection components and operate as a cap for a container, such as container 400. In such embodiments, the user may hold the container body with the applicator 410 connected thereto when spreading and smoothing the sodium silicate solution in the damaged area of a screen. In some embodiments, the applicator 410 may be combined with a container (e.g. container 400) as a single screen repair kit.

The applicator 410 also includes an interface section 412 that facilitates the connection to the application section 416. In some embodiments, the interface section 412 may also operate to allow an applicator cap (not shown) to be connected over the application section 416.

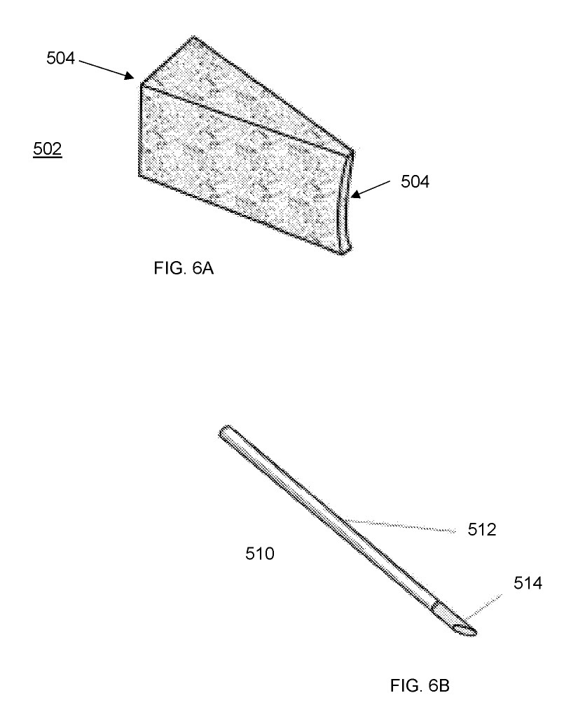

FIGS. 6A and 6B illustrate additional embodiments of applicators. FIG. 6A shows a wedge applicator 502. The wedge applicator 502 has a wide section 504 on one end with a narrow section 506 on the opposite end. In this embodiment, the wedge applicator 502 is shown having a consistent material throughout. The material may be selected or designed to prevent or limit the likelihood of damage to the screen surface while facilitating the application of the sodium silicate solution. In some embodiments, the material may be a foam composite, a rubber, a plastic, a nylon and/or another material or combination of materials. In some embodiments, the wedge applicator 502 may provide a variety of surface attributes that may be used to spread and smooth a sodium silicate solution on a screen. In addition, the dimensions of the applicator 502 may vary based upon various factors, such as the intended use of the applicator 502, the intended packaging for the applicator 502 (or a kit including the applicator 502) and/or other considerations.

A user may hold the wedge applicator 502 in a variety of manners depending on the selected application surface. In other words, a user may hold the wide section 504 when using the narrow section 506 or another surface to spread and smooth the sodium silicate solution. Alternatively, a user may hold the narrow section 506 when using the wide section 504 or another surface to spread and smooth the sodium silicate solution. During use, a person may wipe the wedge applicator 502 over the damaged area of the screen to smooth the sodium silicate solution across the damaged area. During the process, the wedge applicator 502 may remove excess sodium silicate solution. In addition, the wedge applicator 502 material may be selected to absorb excess sodium silicate solution.

In some embodiments, the sodium silicate solution may be applied to the wedge applicator when the material of the wedge applicator 502 allows absorption. The wedge applicator 502 may then transfer the sodium silicate solution to the damaged area of the screen as part of the application process.

In some embodiments, a user may use the wedge applicator 502 to apply a sufficient amount of water or other fluid to a previously repaired area having a dried sodium silicate solution. The water or other fluid may allow the sodium silicate solution to be further smoothed or removed. For example, a user may dip the wedge applicator 502 in water and apply the wet wedge applicator 502 to a section of the sodium silicate solution that dried in an uneven manner. The wedge applicator 502 may then be used to wipe the surface smoothing the sodium silicate solution and even removing excess sodium silicate solution.

FIG. 6B shows a stick applicator 510. The stick applicator 510 has a handle section 512 on one end with an application section 514 on the opposite end. In some embodiments, the handle section 512 is rigid with a softer material as the application section 514. In some embodiments, the handle section 512 may be a semi-rigid design. The material for the handle section 512 may be comprised of rubber, plastic, wood, papers or other composites. The material for the application section 514 may be selected or designed to prevent or limit the likelihood of damage to the screen surface while facilitating the application of the sodium silicate solution. In some embodiments, the material may be a foam composite, a rubber, a plastic, a nylon, fabrics and/or another material or combination of materials. In addition, the dimensions of the applicator 510 may vary based upon various factors, such as the intended use of the applicator 510, the intended packaging for the applicator 510 (or a kit including the applicator 510) and/or other considerations.

The handle section 512 comprises the substantial majority of the stick applicator 510 in this embodiment. In some embodiments, the stick applicator 510 may have a consistent material throughout for the handle section 512 and the application section 514.

A user may hold the handle section 512 of the stick applicator 510 and use the application section 514 to spread and smooth the sodium silicate solution. During use, a person may wipe application section 514 of the stick applicator 510 over the damaged area of the screen to smooth the sodium silicate solution across the damaged area. The stick applicator 510 may remove excess sodium silicate solution.

In some embodiments, the sodium silicate solution may be applied to the stick applicator 510 when the material of the application section 514 allows absorption. The stick applicator 510 may then transfer the sodium silicate solution to the damaged area of the screen as part of the application process. In some embodiments, a user may dip the application portion 514 of the stick applicator 510 into a container holding the sodium silicate solution and allow the application portion 514 to absorb the sodium silicate solution for transfer to a damaged screen.

The screen repair system may be provided as a kit containing one or more of the applicators and the containers of the sodium silicate solution. For example, a kit may comprise a container 300 with a stick applicator 510. The stick applicator 510 may be attached to container 300 to provide a simple kit with everything needed to repair a damaged screen. In some single use embodiments, the stick applicator 510 may be connected by a break away element to allow a single use of the stick applicator 510. In some multi-use embodiments, the stick applicator 510 may be connected by a connection that allows the stick applicator 510 to be reconnected. In some multi-use embodiments, multiple stick applicators 510 may be connected to the container 400 by connections that break away to allow a single use of each stick applicator 510 provided.

As another embodiment of a screen repair kit, an applicator 502 may be provided with multiple containers 200. The same applicator 502 may be reused for each application from one of the container 200 provided in the kit.

The invention being thus described and further described in the claims, it will be obvious that the same may be varied in many ways. Such variations are not to be regarded as a departure from the spirit and scope of the invention and all such modifications as would be obvious to one skilled in the art are intended to be included within the scope of the apparatuses and methods described.

1. A method for repairing a damaged area of a screen for an electronic device comprising:
applying a sodium silicate solution from a container onto said damaged area of the screen, wherein the container comprises a container body which holds said sodium silicate solution and an output from which said sodium silicate solution is applied to said top surface;
spreading the sodium silicate solution over and into the damaged area of the screen with an applicator, wherein said applicator includes an application portion configured to contact said screen when spreading said sodium silicate solution; and
facilitating the sodium silicate solution drying to a hardened state.

2. The method of claim 1, wherein applying said sodium silicate solution comprises compressing said container body to push said sodium silicate solution out of the output onto said damaged area of the screen.

3. The method of claim 1, said sodium silicate solution comprises water and sodium silicate.

4. The method of claim 3, wherein said sodium silicate solution comprises between 80 percent and 30 percent water and 20 percent and 70 percent sodium silicate.

5. The method of claim 3, wherein said sodium silicate solution comprises 37.5 percent water and 63.5 percent sodium silicate.

6. The method of claim 1, wherein spreading said sodium silicate solution comprises pressing the sodium silicate solution into one or more fissures in said damaged area and smoothing the sodium silicate solution over the damaged area.

7. The method of claim 1, wherein facilitating the sodium silicate solution drying comprises blowing air over the sodium silicate solution.

8. The method of claim 1, wherein facilitating the sodium silicate solution drying comprises applying heated air to the sodium silicate solution.

9. The method of claim 1, wherein said screen is for a touch screen display.

10. A system for repairing a damaged area of a screen for an electronic device comprising:
a container having a container body and a container output;
a sodium silicate solution within said container, comprising water and sodium silicate; and
an applicator having an application portion for spreading said sodium silicate solution onto said damaged area of said screen, wherein said applicator is connected to said container prior to use.

11. The system of claim 10, wherein said screen is for a touch screen display.

12. The system of claim 10, comprising a container cap that fits over said container output and attaches to said container body.

13. The system of claim 10, wherein said applicator is part of a container cap that fits over said container output and attaches to said container body.

14. The system of claim 10, wherein said sodium silicate solution comprises water and sodium silicate.

15. The system of claim 14, wherein said sodium silicate solution comprises between 30 percent and 80 percent water and 20 percent and 70 percent sodium silicate.

16. The system of claim 14, wherein said sodium silicate solution comprises 37.5 percent water and 63.5 percent sodium silicate.

17. The system of claim 10, wherein said container body is compressible, and said wherein said container output comprises an opening configured to limit the release of said sodium silicate solution when the container body is in a default configuration and allow the release said sodium silicate solution when the container body is compressed.

18. The system of claim 10, wherein said applicator is a wedge applicator.

19. The system of claim 10, wherein said applicator is a stick applicator.

20. The system of claim 10, wherein said application portion comprises at least one of a foam composite, a rubber, a plastic, a nylon and/or a fabric.
